(19) United States
(12) Patent Application Publication
(10) Pub. No.: US 2004/0224076 A1
(43) Pub. Date: Nov. 11, 2004

(54) Dietetic composition in the form of a salt substitute for table salt

(76) Inventors: Marcel Derrien, Rambouillet (FR); Anne-Marie Fontvieille, Le Vesinet (FR)

Correspondence Address: SANOFI-SYNTHELABO INC., 9 GREAT VALLEY PARKWAY, P.O. BOX 3026, MALVERN, PA, 19355, US

(21) Appl. No.: 10/864,821

(22) Filed: Jun. 8, 2004

Related U.S. Application Data
(63) Continuation of application No. 09/600,968, filed on Jul. 25, 2000, now abandoned.
Application No. 09/600,968 is a 371 of international application No. PCT/FR99/00098, filed on Jan. 20, 1999.

(30) Foreign Application Priority Data
Jan. 26, 1998 (FR) 98 00800

(51) Int. Cl. A23L 1/30

(52) U.S. Cl. 426/648

(57) ABSTRACT

The present invention relates to a dietetic composition in the form of a salt substitute for table salt, characterized in that it comprises, by weight, from:

40% to 50% of potassium chloride

15% to 25% of sodium chloride

15% to 25% of one or more calcium salts

8% to 15% of one or more magnesium salts.

The present invention relates in general to a dietetic composition in the form of a salt substitute for common table salt.

In particular, the invention relates to a dietetic composition in the form of a low-sodium substitute salt which is useful as a supplement in the case of mild or moderate high blood pressure.

The benefit of a pharmacological correction of high blood pressure on the risk of cardiovascular complications has been clearly demonstrated.

Thus, a/decrease in blood pressure of 6 mm Hg causes a reduction in the risk of cerebrovascular accidents and of myocardial infarction of 42 and 14%, respectively.

For this reason, a nonpharmacological approach has been generally recommended in the case of high blood pressure at least in the initial phase of the management of a mild or even moderate hypertension, or in combination with a drug treatment.

This attitude is motivated by the abundant literature which shows a statistical or even physiopathological relationship between certain factors and high blood pressure. Thus, nicotine addiction, excessive alcohol consumption, being overweight, certain dietary imbalances relating to the supply of sodium, potassium, calcium and magnesium, stress and sedentary lifestyle are implicated as factors or cofactors in the onset, maintenance or worsening of hypertension.

The results of numerous studies tend to show the important role of mineral salts in the regulation of blood pressure: sodium is thought to increase this pressure whereas the opposite appears to be demonstrated for potassium and magnesium.

Indeed, epidemiological studies suggest an inverse relationship between the dietary supply of K⁺ ion and the prevalence of high blood pressure.

A meta-analysis published in JAMA: 1997; 277: 1624-1632 and relating to 33 studies in fact reports that oral supplementation with potassium is associated with a reduction of 3.11 mm Hg for systolic pressure and 1.97 mm Hg for diastolic pressure. The hypotensive effect would, in addition, appear to be more marked in subjects who have a higher sodium consumption.

Thus, it appears demonstrated that an additional supply of K⁺ ion could decrease blood pressure.

In populations used to a diet high in potassium, the incidence of cerebrovascular accidents in fact appears to be low.

Furthermore, it has been shown that a provoked depletion of potassium, of short duration, aggravates a preexisting hypertension and induces an increase in blood pressure in volunteers with normal blood pressure. Among the numerous mechanisms invoked, the most important appears to be the natriuretic effect of the K⁺ ion, which would explain the poor response obtained during additional supplies of potassium in persons under sodium restriction.

Numerous studies have shown, moreover, a more marked relationship of the Na⁺/K⁺ ratio with blood pressure than with Na⁺ or K⁺ alone. The result is that the dietetic measures for reducing blood pressure appear to be more effective when the supplies of different mineral salts are changed simultaneously.

Thus, following intervention studies, it appears reasonable to encourage a diet high in potassium or to have recourse to supplementation.

Moreover, an additional supply of magnesium is likewise recommended in hypertensives. This recommendation is based on observations which were initially carried out in rats where a magnesium deficiency causes the appearance of a marked hypertension.

Furthermore, the Mg⁺⁺ ion, a natural vasodilator antagonist of the Ca⁺⁺ ion at numerous levels, constitutes a cofactor for numerous enzymes and its deficient presence could produce haemodynamic deteriorations and ventricular arrhythmias.

Recently, it has in fact been demonstrated that the Mg⁺⁺ ion, administered in the acute phase of myocardial infarction reduces the onset of arrhythmias and mortality.

An additional supply of magnesium is in addition indicated during resistant hypokaliemia generally due to a hypomagnesemia. This supplementation can in fact be tried for a few weeks without any major risk when a deficiency is identified or is highly suspected.

Furthermore, the benefit of a simultaneous additional supply of potassium and magnesium with a decrease in the supply of sodium in particular for a decrease in blood pressure has been clearly demonstrated.

For example, a study carried out over 24 weeks in elderly persons with a moderate hypertension has been published in British Medical Journal 1994; 309: 436-440.

Following this study, it has been possible to show that the replacement of common table salt (sodium chloride) with a salt containing 41% of sodium chloride, 41% of potassium chloride, 17% of magnesium salts and 1% of minerals in trace amounts causes a reduction of 7.6 mm Hg in systolic pressure and of 3.3 mm Hg in diastolic pressure.

These results lead to the conclusion that a substitute salt low in Na⁺ ion but enriched with K⁺ ion and with Mg⁺⁺ ion offers an advantageous nonpharmacological approach for reducing mild to moderate hypertension.

This trial, like others also published (Circulation Supplement, 1996, vol. 94, No. 8, p. 1983) suggest, consequently, that the replacement of common table salt with a salt low in Na⁺ ion but, on the other hand, high in K⁺ an/a Mg⁺⁺ ions could be of interest as therapeutic adjuvant in particular in the treatment of moderate hypertension.

Numerous other compositions useful as substitute salts have been proposed in order to reduce the daily supply of Na⁺ ion.

Among these are in particular substitute salts with a reduced sodium content but enriched with potassium and magnesium in substantial quantities.

To this effect, there may be mentioned:

a) patent GB 2015803 which describes a substitute salt containing, by weight of the composition, 50 to 65% of NaCl, 20 to 40% of KCl or K₂SO₄ and 5 to 20% of MgCl₂ or MgSO₄,

b) U.S. Pat. No. 4,473,595 which reports a substitute salt containing, by weight of the composition, 40 to 50% of NaCl, 25 to 35% of KCl and 15 to 25% of MgCl₂ or MgSO₄.

However, salt substitutes for table salt including sodium, potassium, magnesium and calcium salts are also known and have been published.

However, the magnesium salts and calcium salts are present therein in relatively low quantities.

There may be mentioned, to this effect:

c) U.S. Pat. No. 4,107,346 where a replacement composition for table salt is described which comprises Na⁺, K⁺, Mg⁺⁺ and Ca⁺⁺ ions, in proportions substantially corresponding to those present in the extracellular fluids of the human body, these proportions comprising, by weight, 92 to 93.1% of Na⁺ ion; 2.4 to 3.4% of K⁺ ion; 3.1 to 3.4% of Ca⁺⁺ ion; 1.2 to 1.4% of Mg⁺⁺ ion.

d) patent GB 2237720 which cites a dietetic salt consisting of sea salt or rock salt enriched with KCl, that is to say having a final composition comprising, by weight, 46.6% of NaCl; 6.5% of MgCl₂; 2.8% of MgSO₄; 2.2% of CaSO₄; 41.5% of KCl; 0.10% of MgBr₂ and 0.2% of CaCO₃.

e) patent EP 0291578 which describes a table salt substitute containing 40 to 85% by weight of rock salt, 5 to 45% by weight of KCl, 2 to 10% by weight of of CaCO₃ and 2 to 10% by weight of MgCO₃.

It will be observed, however, that in each of the substitute salts of the state of the art reported above, sodium chloride remains present in an amount of at least 40% by weight, that is to say in a relatively large quantity.

The search for a salt substitute for common table salt, comprising potassium chloride, a magnesium salt as well as sodium chloride, itself in a quantity by weight proportionally lower than in the previous compositions, this substitute salt having, furthermore, acceptable taste qualities and salting power, remains of paramount interest.

Now, it has been found, surprisingly, that by partially replacing, with calcium salts, the sodium chloride of the substitute salts of the prior art, it is possible to obtain compositions which can be used as dietetic supplements in mild or moderate hypertension while possessing at the same time a taste which is quite similar to that of common table salt and a salting power substantially equal to or even higher than it.

The subject of the present invention is therefore a dietetic composition, in the form of a salt substitute for table salt, comprising by weight, from:

40% to 50% of potassium chloride

15% to 25% of sodium chloride

15% to 25% of one or more calcium salts

8% to 15% of one or more magnesium salts.

As calcium salt, a phosphate, that is to say monocalcium phosphate, dicalcium phosphate, tricalcium phosphate or calcium glycerophosphate, is advantageously used. This calcium salt may also be calcium dicitrate or calcium D-gluconate.

However, monocalcium phosphate, that is to say Ca(H₂PO₄)₂, is preferred.

Likewise, the magnesium salt may be a magnesium phosphate, magnesium gluconate or dibasic magnesium citrate. The latter is in fact preferably used in the dietetic compositions according to the invention.

It is observed, in addition, that the calcium or magnesium salts present in the dietetic compositions according to the invention, in particular monocalcium phosphate and dibasic magnesium citrate possess taste qualities which are generally superior to those of calcium lactate, chloride or hydroxide or alternatively magnesium chloride or sulphate.

To allow them ease of flow and without formation of agglomerates, the compositions according to the invention will contain, if necessary, one or more antiagglomerating agents in an amount of 0.5% to 2.5% by weight of the total composition, in particular 0.5% to 1% by weight of this composition.

Magnesium carbonate is normally used as antiagglomerating agent.

However, other agents of this type, such as colloidal silica, magnesium silicate, stearic acid, magnesium stearate or a calcium phosphate can be advantageously envisaged.

Furthermore, the dietetic compositions according to the invention may optionally contain one or more taste-enhancing agents, in an amount of 0.5% to 2.5% by weight of the total composition, in particular from 0.5% to 2% by weight of this composition. This taste enhancer, which contributes in particular to the masking of the bitterness of the K⁺ ion and to the impression of saltiness, is preferably glutamic acid, a glutamate such as calcium glutamate or magnesium glutamate, ascorbic acid, an ascorbate such as calcium ascorbate or magnesium ascorbate, citric acid or a citrate such as calcium citrate or magnesium citrate.

If necessary, the dietetic compositions according to the invention may include traces of an iodinated compound, preferably potassium iodide, in order to obtain an iodinated substitute salt. This iodinated compound, and preferably potassium iodide, is normally added in an amount of about 0.01% by weight of the final composition.

According to a particular and preferred aspect, the invention relates to a dietetic composition in the form of a salt substitute for table salt, comprising, by weight, from:

45% to 50% of potassium chloride

15% to 20% of sodium chloride

15% to 20% of one or more calcium salts

10% to 15% of one or more magnesium salts

and optionally from:

0.5% to 1% of one or more antiagglomerating agents

0.5% to 2% of one or more taste-enhancing agents.

The dietetic compositions according to the invention have proved to be free of after taste and of bitter taste and their use as condiment or a source of seasoning gives a perception of a taste similar to that of table salt or sodium chloride.

In addition, in spite of their low content of sodium chloride, the dietetic compositions according to the invention, through their completely advantageous salting power, could reduce by at least 60% the daily consumption of Na⁺ ion.

Compared with the substitute salts of the state of the art, the dietetic compositions according to the invention are mainly characterized by the replacement of a certain proportion by weight of sodium chloride with an equivalent proportion of one or more calcium salts.

These calcium salts not only confer on the compositions according to the invention completely acceptable taste qualities but significantly contribute to controlling mild or moderate hypertension.

Indeed, it is known that the increase in the dietary supply of calcium reduces blood pressure and favourably affects the arterial function of the smooth muscle in different forms of experimental hypertension.

Thus, the dietetic compositions according to the invention, in the form of salt substitutes for table salt, can be advantageously used to increase the supply of magnesium and calcium. In this regard, they are particularly advantageous from the nutritional point of view. These supplies are often insufficient in subjects with mild or moderate high blood pressure.

The subject of the present invention is also the use of a composition as defined above or below as adjuvant in the treatment of mild or gravidic high blood pressure, in the prevention of high blood pressure, in the correction of magnesium deficiencies, in the prevention or treatment of hydrosodium retention or alternatively in persons wishing to reduce their consumption of common table salt. The composition claimed is in particular useful for the preparation of a pharmaceutical composition useful for the treatment of mild or gravidic high blood pressure, the prevention of high blood pressure, the correction of magnesium deficiencies and/or the prevention or treatment of hydrosodium retention.

Sensory analyses have been carried out in order to determine the mean value of iso-salty concentrations of a substitute salt according to the invention having the formulation by weight:

| | |
|---|---|
| potassium chloride | 45% |
| sodium chloride | 20% |
| monocalcium phosphate | 20% |
| dibasic magnesium citrate | 12% |
| magnesium carbonate | 1% |
| ascorbic acid | 1% |
| glutamic acid | 1% |

and this being compared with table salt. “Iso-salty concentration” is understood to mean the concentration of the substitute salt according to the invention which gives the same salty intensity in the mouth as a reference solution of table salt.

These results have then made it possible to calculate the salting power of this substitute salt represented by the ratio between the concentration of the reference solution and the mean value of the iso-salty concentrations determined during several trials.

a) Iso-Salty Concentration in Mashed Potato

The so-called “up-and-down” method is used to this effect whose benefit is to make it possible to very rapidly obtain a correct estimation of the salting intensity of a solution or of a food compared with a solution or with a reference food containing a given concentration of table salt (NaCl).

This method consisted in presenting, to a group of 27 experienced and trained tasters, stimuli of increasing or decreasing intensity according to the responses of the subjects.

A protocol was used to this effect similar to that of a test of classifying in pairs, each pair consisting of a variable stimulus (substitute salt of the invention) and a constant reference (table salt).

In the above test, there is used as reference a mashed potato containing 0.6 g of table salt (NaCl)/100 g of mashed potato and as variable stimulus a range of 8 decreasing concentrations of the substitute salt of the invention, from a maximum concentration of 4 g/100 g of mashed potato with a decreasing step of 1.5.

Consequently, the concentrations of substitute salt were 4 g/100 g; 2.67 g/100 g; 1.77 g/100 g; 1.18 g/100 g; 0.79 g/100 g; 0.53 g/100 g; 0.35 g/100 g; 0.23 g/100 g; 0.16 g/100 g.

During the tests, the mashed potatoes were kept hot in yoghurt machines. In addition, the experimenters operated binomially, one experimenter being a taster, the other a tester, and then the roles were reversed.

On each presentation of the pairs to be tasted, the taster experimenter should assess which of the two mashed potatoes was the more salty.

A mean value of iso-salty concentrations of 0.33 g/100 g of mashed potato was thus found.

In other words, on average 0.33 g of substitute salt was needed in 100 g of mashed potato to confer the same salty taste intensity as 0.6 g of table salt in 100 g of mashed potato.

b) Salting Power in the Mashed Potato

The salting power detected by a subject corresponds to the ratio of the reference concentration to the mean value of the iso-salty concentrations whereas the salting power detected by the group of experimenters is equal to the mean of the salting powers obtained for each subject.

In the above test, the salting power of the substitute salt detected by the group of experimenters was 2.07.

In conclusion, the salting power of the substitute salt of the invention in the mashed potato is quite remarkable given its low content of sodium chloride (20% by weight).

Taken in this food, the substitute salt could reduce by 90% the sodium chloride supplies while allowing a coverage of 28% of the recommended daily supplies of Mg⁺⁺ ion and of 45% of the recommended daily supplies of Ca⁺⁺ ion for 5 g of daily consumption.

The dietetic compositions according to the invention can be prepared by mixing, after calibration, the different ingredients entering into the formulation so as to obtain a homogeneous mixture free of segregation.

The following nonlimiting example illustrates the preparation of such a dietetic composition of the invention.

### EXAMPLE

A dietetic composition of the invention is prepared which has the formula:

| | |
|---|---|
| potassium chloride | 45% |
| sodium chloride | 20% |
| monocalcium phosphate | 20% |
| dibasic magnesium citrate | 12% |
| magnesium carbonate | 1% |
| ascorbic acid | 1% |
| glutamic acid | 1% |

by application of the following method:

All the ingredients entering into the composition are weighed and premix is prepared, over 5 minutes and with stirring (24 revolutions/min) on an inverting mixer. The premix is then calibrated on a grid with a mesh opening of 0.8 mm and it is again mixed, with stirring (24 revolutions/min), for 20 minutes.

The mixture obtained is taken up by calibrating it on a grid with a mesh opening of 0.5 mm and then the final mixing is carried out, with stirring (24 revolutions/min), for 15 minutes.

1. A dietetic composition in the form of a salt substitute for table salt consisting essentially of by weight, from:
40% to 50% of potassium chlorides
15% to 25% of sodium chlorides
15% to 25% of one or more calcium salts and
8% to 15% of one or more magnesium salts.

2-13 (Cancelled)

14. A dietetic composition according to claim 1 additionally containing from 0.5% to 2.5% by weight of one or more antiagglomerating agents.

15. A dietetic composition according to claim 1 additionally containing from 0.5% to 2.5% by weight of one or more taste-enhancing agents.

16. A dietetic composition according to claim 15 additionally containing from 0.5% to 2.5% by weight of one or more antiagglomerating agents.

17. A dietetic composition according to claim 14 containing from 0.5% to 1% by weight of one or more antiagglomerating agents.

18. A dietetic composition according to claim 15 containing from 0.5% to 2% by weight of one or more taste-enhancing agents.

19. A dietetic composition according to claim 18 additionally containing from 0.5% to 1% by weight of one or more antiagglomerating agents.

20. A dietetic composition according to claim 1 consisting essentially of by weight from:
45% to 50% of potassium chloride,
15% to 20% of sodium chloride,
15% to 20% of one or more calcium salts, and
10% to 15% of one or more magnesium salts.

21. A dietetic composition according to claim 20 additionally containing from 0.5% to 1% by weight of one or more antiagglomerating agents.

22. A dietetic composition according to claim 20 additionally containing from 0.5% to 2% by weight of one or more taste-enhancing agents

23. A dietetic composition according to claim 22 additionally containing from 0.5% to 1% by weight of one or more antiagglomerating agents.

24. A dietetic composition according to claim 23, wherein the calcium salt is selected from the group consisting of monocalcium phosphate, dicalcium phosphate, tricalcium phosphate, calcium glycerophosphate, calcium dicitrate and calcium D-gluconate.

25. A dietetic composition according to claim 24, wherein the magnesium salt is selected from the group consisting of a magnesium phosphate, magnesium gluconate and dibasic magnesium citrate.

26. A dietetic composition according to claim 25, wherein the calcium salt is monocalcium phosphate.

27. A dietetic composition according to claim 26, wherein the magnesium salt is dibasic magnesium citrate.

28. A dietetic composition according to claim 27, wherein at least one antiagglomerating agent is selected from the group consisting of magnesium carbonate, colloidal silica, magnesium silicate, stearic acid, magnesium stearate and a calcium phosphate.

29. A dietetic composition according to claim 28, wherein at least one taste-enhancing agent is selected from the group consisting of glutamic acid, calcium glutamate, magnesium glutamate, ascorbic acid, calcium ascorbate, magnesium ascorbate, citric acid, calcium citrate and magnesium citrate.

30. A dietetic composition according to claim 29, additionally containing 0.01% by weight of potassium iodide.

31. A dietetic composition according to claim 29 consisting essentially of by weight:
45% of potassium chloride,
20% of sodium chloride,
20% of monocalcium phosphate,
12% of dibasic magnesium citrate,
1% of magnesium carbonate,
1% of ascorbic acid, and
1% of glutamic acid.

32. A method for increasing the dietary supply of magnesium and calcium which comprises utilizing in place of common table salt a composition according to claim 1.

33. A method for increasing the dietary supply of magnesium and calcium which comprises utilizing in place of common table salt a composition according to claim 31.

34. A method for the treatment of mild or gravidic high blood pressure, the prevention of high blood pressure, the correction of magnesium deficiencies and/or the treatment or prevention of hydrosodium retention, which comprises utilizing in place of common table salt a composition according to claim 1.

35. A method for the treatment of mild or gravidic blood pressure, the prevention of high blood pressure, the prevention of high blood pressure, the correction of magnesium deficiencies and/or the treatment or prevention of hydrosodium retention which comprises utilizing in place of common table salt a composition according to claim 31.
